(19) United States
(12) Patent Application Publication
(10) Pub. No.: US 2021/0180551 A1
(43) Pub. Date: Jun. 17, 2021

(54) FUEL INJECTION DEVICE

(71) Applicant: ZAMA JAPAN CO. LTD., Iwate (JP)

(72) Inventors: Toshinobu Shimoyama, Iwate (JP); Takashi Kawashima, Iwate (JP); Hiroo Ubukata, Iwate (JP); Yuri Sato, Iwate (JP); Hideki Watanabe, Iwate (JP)

(21) Appl. No.: 17/120,125

(22) Filed: Dec. 12, 2020

(30) Foreign Application Priority Data
Dec. 13, 2019 (JP) 2019-225713

(51) Int. Cl. F02M 53/04; F02M 51/06; F02M 37/00

(52) U.S. Cl. CPC F02M 53/043; F02M 37/0052; F02M 51/0614

(57) ABSTRACT

Disclosed are example embodiments of an electronic fuel injection device. In one example embodiment, the electronic fuel injection device includes: a yoke having an inner chamber; an armature and a plunger slidably disposed inside the inner chamber of the yoke; a cylindrical bobbin configured to receive the yoke; an electromagnetic coil disposed around an outside surface of the cylindrical bobbin; and a fuel return path formed between an outer surface of the yoke and an inner surface of the cylindrical bobbin. The inner surface of the cylindrical bobbin comprises surface cooling features, including channels or protrusions, configured to remove heat from the cylindrical bobbin.

### CROSS-REFERENCED TO RELATED APPLICATION

The subject application claims the benefit of Japanese Patent Application No. 2019-225713, filed Dec. 13, 2019, which application is incorporated herein by reference in its entirety.

### TECHNICAL FIELD

The disclosure relates generally to the field of fuel injection devices. Specifically and not by way of limitation, the disclosure relates to electronic fuel injection devices that inject fuel using a plunger.

### BACKGROUND

Conventional electronically controlled fuel injection devices are designed to inject fuel from an injection nozzle into an air intake of an engine by pumping fuel from a fuel tank, which is arranged at a lower position than the position of the intake pipe (for a gravity assisted pump), and return excess fuel and generated or inflowing air bubbles to the fuel tank through a pipe line as described, for example, in Japanese Unexamined Patent Application No. 2008-163875. Such conventional electronically controlled fuel injection devices have been adopted in engines such as, for example, those in motorcycles and the like.

FIG. 1 illustrates a conventional electronically controlled fuel injection device 100 that injects compressed fuel into a compression chamber 5 using a plunger 2. Fuel is injected into compression chamber 5 via an intake pipe 4, which is positioned lower than the fuel tank (not shown) to enable gravity-assisted injection.

This conventional electronically controlled fuel injection device injects compressed fuel from an injection nozzle 6, which is disposed downstream, into an air intake of an engine (not shown) by supplying fuel to compression chamber 5 from fuel-intake pipe 4. Plunger 2 is reciprocated by an electromagnetic coil 3 to attain a predetermined reciprocation from an idling position together with an armature 1.

Additionally, fuel injection device 100 integrates a fuel pump and fuel injection valve with a plunger 2, which is driven by the electromagnetic coil 3. Because the fuel pump portion also functions as a pressure regulator, vapor is generated when the fuel is compressed. For that reason, a portion of the fuel (e.g., the fuel vapor) supplied to the compression chamber 5 is returned to the fuel tank (not shown in the drawings) from the fuel-return pipeline 10 via a return path 9. Return path 9 is formed between an outside face 71 of an inner yoke 7 that surrounds the armature 1 and an inner wall face 81 in the bobbin 8 around which is wrapped the electromagnetic coil 3 disposed at an outer circumference thereof,

Because it is necessary to adequately compress the fuel by driving plunger 2 in the electronically controlled fuel injection device, the return path 9 must be shielded when slightly driven for the entire driving distance of the plunger 2. As such, the time for discharging the vapor is not adequately long enough. Also, it is necessary to lengthen the plunger 2 driving distance to implement adequate fuel compression. For the same reason, the electromagnetic coil 3 is made larger.

There is also a tendency for the device's temperature to rise because the energizing time for the electromagnetic coil 3 is longer. The temperature rise can cause vapor to be generated in the compression chamber. Conventional devices have employed various methods of injection control to reduce an effect of vapor. However, start-up performance in those conventional devices is poor at a high-temperature holding state, and the issue of engines not starting persists.

### SUMMARY

One of the objectives of the present disclosure is to provide an electronically controlled fuel-injection device that solves the problems described above by: reducing a generation of vapor by suppressing a temperature rise of an electromagnetic coil; reducing a change in a resistance value of the electromagnetic coil by suppressing the temperature rise of the electromagnetic coil; preventing a change in a current value flowing to the electromagnetic coil caused by the rise in temperature when running the device at a fixed voltage; and driving the armature with a stable excitation ability.

Disclosed are example embodiments of an electronically controlled fuel-injection device. In one example embodiment, the electronically controlled fuel-injection device includes: a yoke having an inner chamber; an armature and a plunger slidably disposed inside the inner chamber of the yoke; a cylindrical bobbin configured to receive the yoke; an electromagnetic coil disposed around an outside surface of the cylindrical bobbin; a fuel return path formed between an outer surface of the yoke and an inner surface of the cylindrical bobbin; and surface cooling features, such as a cooling channel or a cooling projection, formed in the inner surface of the cylindrical bobbin to increase the surface area of the inner surface.

In some embodiments, the surface cooling features can be a helical channel or projection disposed along a length of the inner surface. The helical channel can be a right-handed or left-handed helical pathway. In some embodiments, the surface cooling features can be a straight-line shape channel or projection disposed along a length of the inner surface. The surface cooling features can also be a plurality of surface protrusions or depressions.

In another example embodiment, the electronic fuel injection device includes: a yoke having an inner chamber; an armature and a plunger slidably disposed inside the inner chamber of the yoke; a cylindrical bobbin configured to receive the yoke; an electromagnetic coil disposed around an outside surface of the cylindrical bobbin; and a fuel return path formed between an outer surface of the yoke and an inner surface of the cylindrical bobbin.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a cross-sectional view of a conventional electronically controlled fuel injection device.

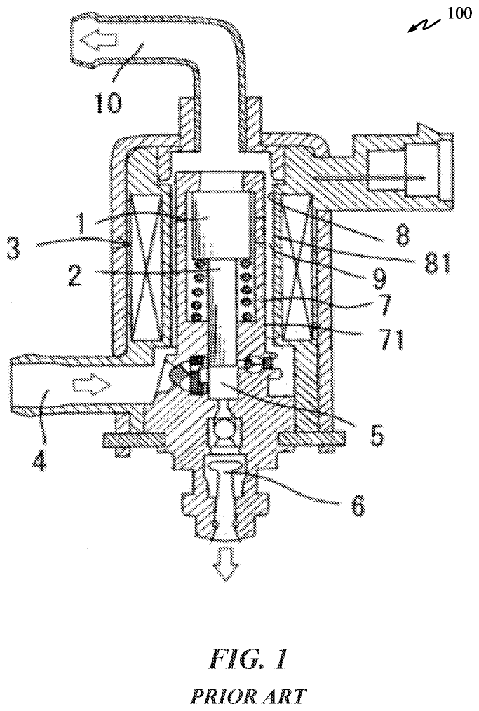

FIG. 2 is a cross-sectional view of an electronically controlled fuel injection device in accordance with some embodiments of the present disclosure.

FIG. 3 is a perspective view a bobbin in accordance with some embodiments of the present disclosure.

FIG. 4 is a perspective view of a bobbin in accordance with some embodiments of the present disclosure.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

### Overview

Disclosed herein is an improved electronically controlled fuel injection device (hereinafter improved fuel injection device) that inhibits the generation of fuel vapor by minimizing the rise of temperature of the fuel injection device caused by the electromagnetic coil. The improved fuel injection device can suppress the temperature rise of the electromagnetic coil by reducing a change in a resistance value of the electromagnetic coil. This prevents a change in a current value flowing to the electromagnetic coil when there is a rise in temperature caused by the device running at a fixed voltage. This also enables the stable excitation of the electromagnetic coil to reciprocate the armature.

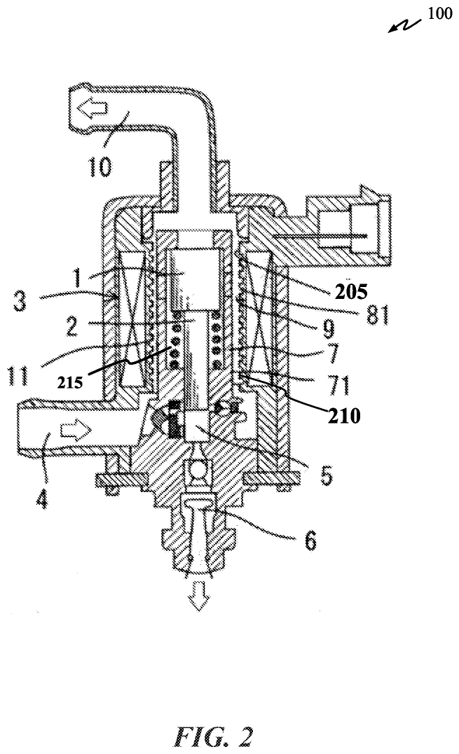

The improved fuel injection device of the present invention includes a plunger that moves in a predetermined reciprocating manner from an idling (e.g., standby) position together with an armature. The reciprocating motion of the plunger and armature is caused by the alternating magnetic field generated by the electromagnetic coil, which is made with electrical wire wrapped at the outer surface (e.g., wall) of a bobbin (see item 205 of FIG. 2). In some embodiments, the bobbin can be a cylindrical bobbin and the electromagnetic coil is arranged on the outer periphery thereof.

The fuel (stored in the fuel tank) is supplied to the pressurizing chamber from the fuel intake pipeline and the pressurized fuel is injected into the engine from the injection nozzle by exciting the electromagnetic coil to reciprocate the armature. A portion of the fuel supplied to the pressurizing chamber is passed through a return passage formed between the outer surface of the inner yoke (surrounding the outside of the armature) and the inner surface of the bobbin.

In some embodiments, one or more surfaces (e.g., walls) of the return channel of the improved fuel injection device can include surface features (see item 210 in FIG. 2) to increase the surface area of the one or more surfaces for cooling. For example, the inner surface of the bobbin can include surface features such as, but not limited to, cooling grooves to increase the surface area available for heat exchange. The grooves act as cooling grooves or cooling protrusions on the inner surface of the bobbin. In another example, the surface features can be surface depressions, raised patterns, or dimples such as dimples on a golf ball.

A part of the fuel supplied to the pressurizing chamber is passed through a return passage formed between the outer surface of the inner yoke (that surrounds the armature) and the inner surface of the bobbin where the electromagnetic coil is disposed on the opposite side.

In some embodiments, the surface features for cooling can be cooling channels with a helical-path pattern. The helical pattern can be from upstream toward downstream or the reverse. In other words, cooling channel can have a right-handed or left-handed helical pattern. In some embodiments, the surface features (e.g., grooves) can have a straight-line vertical path, or diagonal path with respect to the axis of the electromagnetic coil or bobbin. The additional surface area provided by the surface features enables the inner surface of the bobbin to exhibit an excellent cooling effect on the electromagnetic coil. In other words, the surface features enhance the heat exchange ability of the bobbin and enables it to remove more heat from the electromagnetic coil.

Although embodiments discussed above describe surface features in the form of a cooling channel, it is acceptable to form a cooling projection instead of the cooling channel. Also, the shape is not limited to a helical shape or a straight-line shape. It can go without saying that if return fuel flowing in the return path is not stagnated, by the increase in the surface area of the inner wall face of the bobbin, the cooling channel or the cooling projection shapes may also be another shape (not shown in the drawings).

In this way, the improved fuel injection device can inhibit the generation of vapor by suppressing temperature rises in the electromagnetic coil. In other words, changes in the resistance value of the electromagnetic coil are reduced by suppressing the temperature rise of the electromagnetic coil. This also prevents changes in the current value flowing to the electromagnetic coil caused by the rise in temperature when running the device at a fixed voltage. Another benefit of the improved fuel injection device is smoother and more efficient excitation of the armature.

### Fuel Injection Device With Heat Exchange Features

FIG. 2 is a front view of an electronically controlled fuel injection device 200 in accordance with some embodiments of the present disclosure. Similar to fuel injection device 100, fuel injection device 200 includes armature 1, plunger 2, electromagnetic coil 3, fuel-intake pipe 4, compression chamber 5, injection nozzle 6, inner yoke 7, return path 9 and fuel-return pipe 10. However, fuel injection device 200 includes surface features 210 (e.g., channels 11) on the surface of inner wall face 81 of bobbin 205. Surface features 210 can be grooves, slots, channels, depressions, and/or protrusions designed to increase the total surface are of inner surface 81 of bobbin 205. Surface features 210 can be cooling channels 11 having a helical path along the longitudinal axis of bobbin 205. The helical path can be a right-handed or left-handed helical shape. The channels pathway can also be vertical or diagonal with respect to the longitudinal axis of bobbin 8.

Inner yoke 7 can include an inner chamber 215 or lumen that houses armature 1 and plunger 2. Chamber 215 provides a space for armature to reciprocate (e.g., move back and forth) along the longitudinal axis of chamber 215, which can be the same as the longitudinal axis of yoke 7. The outer surface 71 of yoke 7 and inner surface 81 of bobbin 205 form return path 9.

As mentioned, surface features 210 increase the total surface area of inner surface 81 of bobbin 205. In this way, the heat exchange capability of bobbin 205 is greatly improved. Stated differently, return path 9 is in direct contact with surface features 210 of bobbin 205, which enable heat to be efficiently removed from electromagnetic coil 3. In operation, electromagnetic coil 3 is cooled by the return fuel flowing through a return path 9. In the conventional fuel injection device 100, inner surface 81 of bobbin 8 is smooth and does not have any cooling-surface feature. In contrast, inner surface 81 of bobbin 205 includes surface features 210 (as shown in FIG. 2) which notably improve the heat exchange characteristic of device 200. In this way, electromagnetic coil 300 can remain much cooler in device 200 than in the conventional device 100.

Surface features 210 of device 200 can reduce the generation of vapor by lowering and stabilizing the temperature of electromagnetic coil 3. In other words, surface features 210 can suppress the temperature rise of electromagnetic coil 3, which helps reduce the changes in the resistance value of electromagnetic coil 3. This also helps stabilize the amount of current flowing through the electromagnetic coil 3, which enables the device to run at a fixed voltage and allows the armature to be stably excited.

In some embodiments, surface features 210 can be cooling channel 11 having a helical path running from upstream to downstream on the inner wall face 81 of the bobbin 8. This allows the return fuel to flow without stagnating in the return path 9. In this way, it is possible to quickly eliminate vapor and to remove heat generated in electromagnetic coil 3. In some embodiments, the helical path of the channel can be a right-handed or left-handed.

Cooling channel 11 formed into a single helical shape, right-handed or left-handed, on inner wall face 81 of the bobbin 8. Cooling channel 11 can have more than one channel mutually formed in parallel.

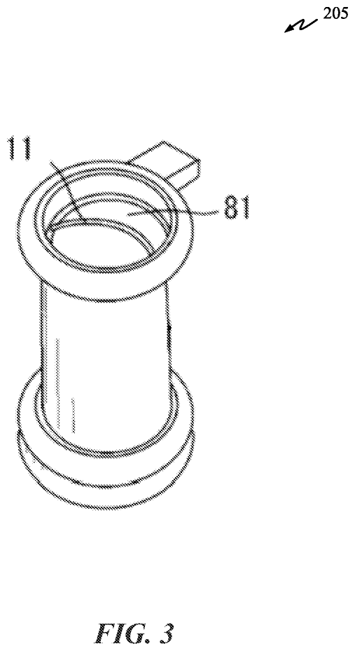

FIG. 3 illustrates bobbin 205 in accordance with some embodiments of the present disclosure. Bobbin 205 includes an inner surface 81 that includes surface features to increase the surface area of inner surface 81. In some embodiments, the surface features can be one or more helical channels 11, which can be right-handed, left-handed, or a combination of both. In some embodiments, the helical pathway of helical channel(s) 11 can be formed from upstream toward downstream.

In some embodiments, outer surface 71 of inner yoke 7 can also have cooling surface features such as cooling channels 11, surface protrusions, and/or surface depressions as described above.

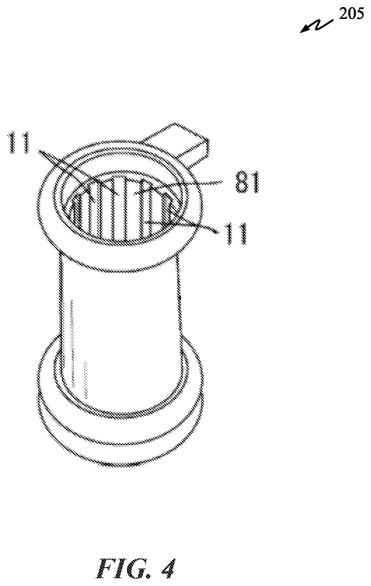

FIG. 4 illustrates bobbin 205 in accordance with some embodiments of the present disclosure. Bobbin 205 includes a plurality of vertical channels 11. The channels provide extra surface area for inner surface 81 while also providing pathways for fuel and/or fuel vapor to return to the fuel tank (not shown). As previously mentioned, the cooling surface features of inner surface 81 are not limited to channels having a helical or straight pathway. The surface features can exhibit other shapes such as, but not limited to, pyramidal protrusions, surface depressions (e.g., dimples), and partial spherical protrusions. Additionally, the surface features can be arranged in a way to help increase the rate of flow of fluid flowing through return channel 9. The surface features can also be arranged in a way such that fuel flowing in the return path is not stagnated by the increase in surface area.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division features, attributes, and other aspects are not mandatory or significant, and the mechanisms that implement the present invention or its features may have different names, divisions and/or formats.

1. A fuel injection device, comprising:
a yoke having an inner chamber;
an armature and a plunger slidably disposed inside the inner chamber of the yoke;
a cylindrical bobbin configured to receive the yoke;
an electromagnetic coil disposed around an outside surface of the cylindrical bobbin;
a fuel return path formed between an outer surface of the yoke and an inner surface of the cylindrical bobbin; and
one or more surface cooling features formed on the inner surface of the cylindrical bobbin.

2. The fuel injection device of claim 1, wherein the one or more surface cooling features comprise one or more channels.

3. The fuel injection device of claim 1, wherein the one or more surface cooling features comprise a helical channel disposed along a length of the inner surface.

4. The fuel injection device of claim 2, wherein the helical channel comprises a right-handed helical pathway.

5. The fuel injection device of claim 2, wherein the helical channel comprises a left-handed helical pathway.

6. The fuel injection device of claim 1, wherein the one or more surface cooling features are oriented parallel to a longitudinal axis of the cylindrical bobbin.

7. The fuel injection device of claim 1, wherein the one or more surface cooling features comprise one or more surface protrusions.

8. The fuel injection device of claim 1, wherein the surface cooling features comprise a plurality of surface depressions.

9. An electronic fuel injection device, comprising:
a yoke having an inner chamber;
an armature and a plunger slidably disposed inside the inner chamber of the yoke;
a cylindrical bobbin configured to receive the yoke;
an electromagnetic coil disposed around an outside surface of the cylindrical bobbin; and
a fuel return path formed between an outer surface of the yoke and an inner surface of the cylindrical bobbin, wherein the inner surface comprises one or more surface cooling features configured to remove heat from the cylindrical bobbin.

10. The electronic fuel injection device of claim 9, wherein the one or more surface cooling features comprise one or more channels.

11. The electronic fuel injection device of claim 9, wherein the one or more surface cooling features comprise a helical channel disposed along a length of the inner surface.

12. The electronic fuel injection device of claim 10, wherein the helical channel comprises a right-handed helical pathway.

13. The electronic fuel injection device of claim 10, wherein the helical channel comprises a left-handed helical pathway.

14. The electronic fuel injection device of claim 9, wherein the one or more surface cooling features are oriented parallel to a longitudinal axis of the cylindrical bobbin.

15. The electronic fuel injection device of claim 9, wherein the one or more surface cooling features comprise one or more of surface protrusions.

16. The electronic fuel injection device of claim 9, wherein the one or more surface cooling features comprises a plurality of surface depressions.

17. In an electronically controlled fuel-injection device that supplies fuel stored in a gasoline tank from a fuel-intake pipe line to a compression chamber by excitingly reciprocating a plunger that implements a predetermined reciprocation from an idling position together with an armature using an electromagnetic coil wrapped with electrical wire at an outer wall face of a cylindrical bobbin arranged at an outer circumference thereof, injects compressed fuel into an engine from an injection nozzle equipped downstream, and returns a portion of the fuel supplied to the compression chamber to the fuel tank from a return pipe line via a return path formed between an outer wall face of an inner yoke that surrounds an outside of the armature and an inner wall face of a bobbin in the electromagnetic coil disposed at an outside thereof; wherein a surface area of the inner wall face is increased by forming one of a cooling channel or a cooling projection in the inner wall face of the bobbin.

18. The electronically controlled fuel-injection device according to claim 1, wherein the cooling channel or cooling projection is formed into a helical shape from upstream toward downstream.

19. The electronically controlled fuel-injection device according to claim 1, wherein the cooling channel or cooling projection is formed into a straight-line shape from upstream toward downstream.
